(19) United States
(12) Patent Application Publication
(10) Pub. No.: US 2005/0198235 A1
(43) Pub. Date: Sep. 8, 2005

(54) Server configuration and management

(76) Inventors: Arvind Kumar, Beaverton, OR (US); Don Neuhengen, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/768,570

(22) Filed: Jan. 29, 2004

(51) Int. Cl. G06F 15/177; G06F 15/173

(52) U.S. Cl. 709/222; 709/223

(57) ABSTRACT

Server configuration and management methods, servers and management modules equipped to practice the methods are described herein.

### TECHNICAL FIELD & BACKGROUND

The present invention is related to the field of data processing.

Advances in microprocessor and related technologies have led to wide spread deployment and adoption of computing devices and client/server computing. Servers may be organized into collections or clusters. Member servers of a collection or cluster may have their own chassis, or they may be in the form of circuit boards (commonly referred to as blade servers).

The member servers may be coupled together in a variety of manners and topologies. For example, they may be coupled together using any one of a number of types of cables in a daisy chain topology. Alternatively, they may be coupled together to form a local area network, with or without using routers/switches.

With the increasing number of servers being employed, configuration and management, even in small or medium enterprises, have become difficult.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a computing environment in accordance with one embodiment of the present invention;

FIG. 2 illustrates a management module in accordance with one embodiment;

FIG. 3 illustrates a member server in accordance with one embodiment;

FIG. 4 illustrates a management server in accordance with one embodiment;

FIG. 5 illustrates the operational flow during an initial power on of a member server, in accordance with one embodiment; and

FIG. 6 illustrates the operational flow for the management server to access and manage a member server, in accordance with one embodiment.

### DETAILED DESCRIPTION OF ILLUSTRATIVE EMBODIMENTS

Embodiments of the present invention include, but are not limited to, manageable servers suitable for use as member servers of a manageable server collection/cluster, management module suitable for use to facilitate management of a server collection/cluster, and management server suitable for use to manage member servers of a manageable server collection/cluster.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

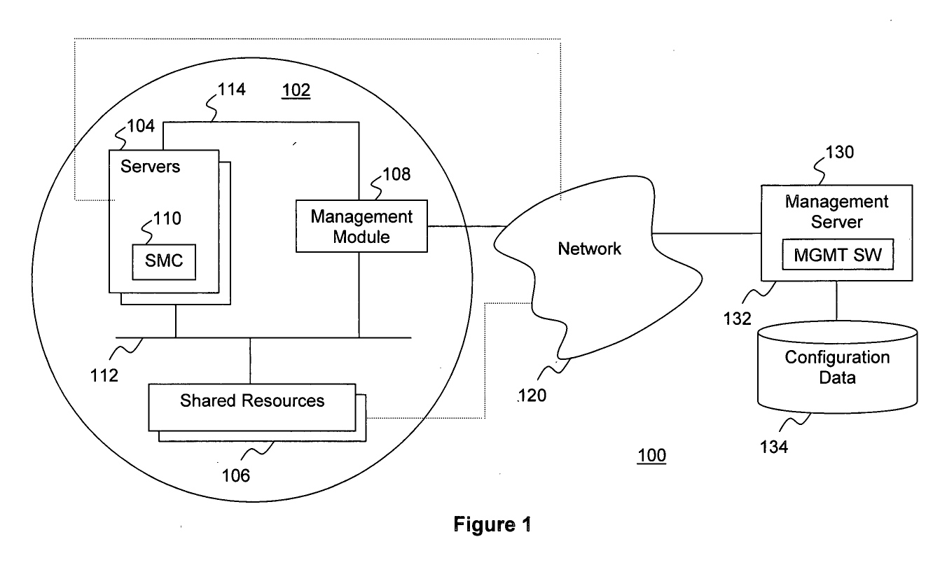

Referring now to FIG. 1, wherein a computing environment in accordance with one embodiment of the present invention is illustrated. As shown, computing environment 100 includes a collection or cluster of servers 102, and a number of management servers 130 coupled to each other via network 120. Collection or cluster of servers 102 may also be referred to as a community of servers.

For the illustrated embodiment, collection/cluster 102 includes a number of member servers 104, a number of shared resources 106, and a management module 108, coupled to each other via system bus 112. Further, member servers 104 and management module 108 may be coupled to each other via a dedicated/secured management interconnect 114. For the embodiment, member servers 104 and shared resources 106 are also illustrated as being coupled to network 120 via “dotted lines”. The “dotted lines” denote the fact that these interconnections are optional, and/or the fact that they are unimportant to the understanding of the present invention. The interconnection between servers 104 and network 120 is also referred to as the “production interconnection” or “production network” at times.

As will be described in more detail below, member servers 104 includes computing resources suitable for performing various computing tasks. Further, at least one of the member servers 104 includes server management controller (SMC) 110 to facilitate configuration and management of the particular member server 104.

As will be also described in more detail below, management module 108 is equipped to facilitate configuration and management (e.g. by one of management servers 130) of member servers 104 (equipped with management controllers 110).

Management communication between SMC 110 of a member server 104 and management module 108 of the community is conducted over management interconnect 114, which may be one of any of a broad range of “interconnects” known in the art or to be designed. Examples of suitable interconnects include but are not limited to the 12C bus, the PCI-Express bus, the RS485 serial bus, a fiber channel, an InfiniBand. (PCI=Peripheral Component Interconnect.) In alternate embodiments, management interconnect 114 may also be a network connection, such as Ethernet, instead. In yet other embodiments, management interconnect 114 may be a virtual connection, e.g. a secure VLAN connection (of e.g. the earlier described “production network”).

The communication between management module 108 and SMC 110 may be conducted in accordance with any one of a number of open or proprietary protocols known in the art or to be designed. In various embodiments, the communication is conducted in accordance with the protocol specified by Intelligent Platform Management Interface (IPMI).

Shared resources 106 may be one or more of a broad range of shareable resources known in the art or to be designed. Examples of shared resources include but are not limited to chassis, power supply, keyboard, video processor, cursor control device, mass storage devices, network interfaces, and so forth.

System bus 112 may be one of any of a broad range of “buses” known in the art or to be designed. Examples of suitable buses include but are not limited to the PCI bus, the Universal Serial Bus (USB), the Institute of Electrical and Electronic Engineer (IEEE) 1394 Serial Bus. In alternate embodiments, system bus 112 may be network connections, such as Ethernet, instead.

In various embodiments, member servers 104 may have their own chassis. In other embodiments, member servers 104 may have the form factor of circuit boards (blade servers).

While for ease of understanding, only one management module 108 is shown for collection/cluster 102. Embodiments of the present invention may be practiced employing more than one management module 108 per collection/cluster 102.

Network 120 may be one or more of a broad range of private and/or public, local and/or wide area networks formed with selected ones of hubs, routers, switches, and so forth. In various embodiments, network 120 includes the Internet.

As illustrated, management server 130 includes in particular management software (MS) 132 and configuration data 134. Configuration data 134 may include parameter values for a broad range of parameters of a broad range of functions/features of member servers 104. These functions/features may include sensors for monitoring member servers 104, to allow member servers 104 to be managed.

As will be described in more detail below, in various embodiments, configuration data 134 may be non-particularized parameter values for various families of member servers, and management module 108 obtains these configuration data from management server 130 based on the server family of a member server, and particularized the configuration data based of the specific deployment of the management server 130 within a collection/cluster 102.

Except for management software 132 and configuration data 134, management server 130 may be any one of a broad range of servers known in the art or to be designed. Similarly, while for ease of understanding, only one management server 130 is shown in computing environment 100, in alternate embodiments, more than one management servers 130 may be employed. In particular, different management servers 130 may be employed to provide configuration data, and manage member servers 104.

Resultantly, member servers 104 may be advantageously configured “online”, as opposed to the current “offline” practice. Further, the tasks of configuring and managing member servers 104 may be made easier.

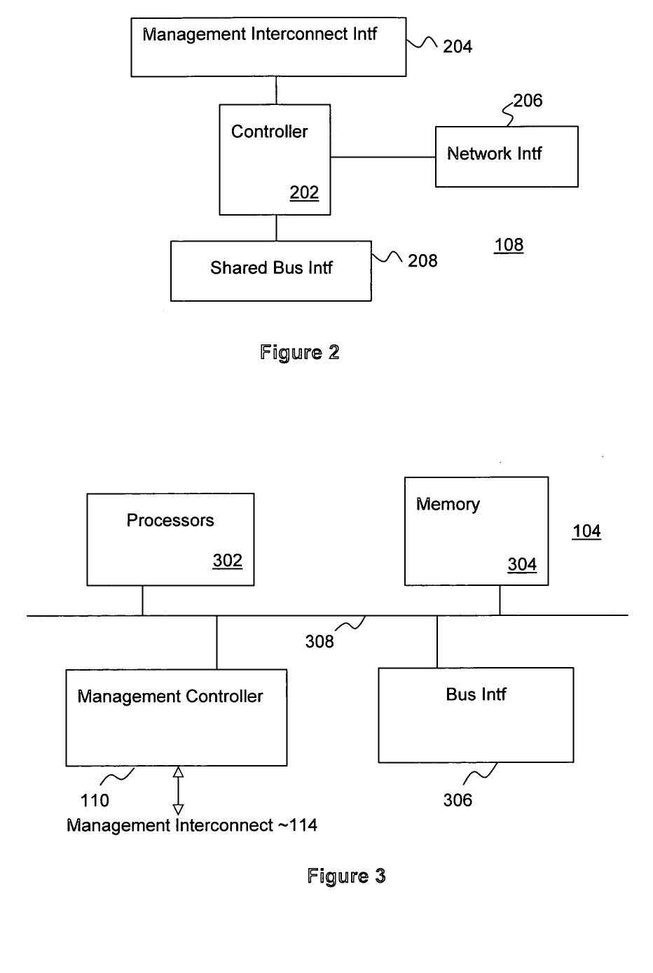

FIG. 2 illustrates management module 108 in further detail, in accordance with one embodiment. For the embodiment, management module 108 includes collection/cluster management controller (CMC) 202 and interfaces 204-208 coupled to each other as shown. Interfaces 204-208 include in particular management interconnect interface 204 for coupling to management interconnect 114, shared bus interface 208 for coupling to shared system bus 112, and network interface 206 for coupling to a network connection to network 120.

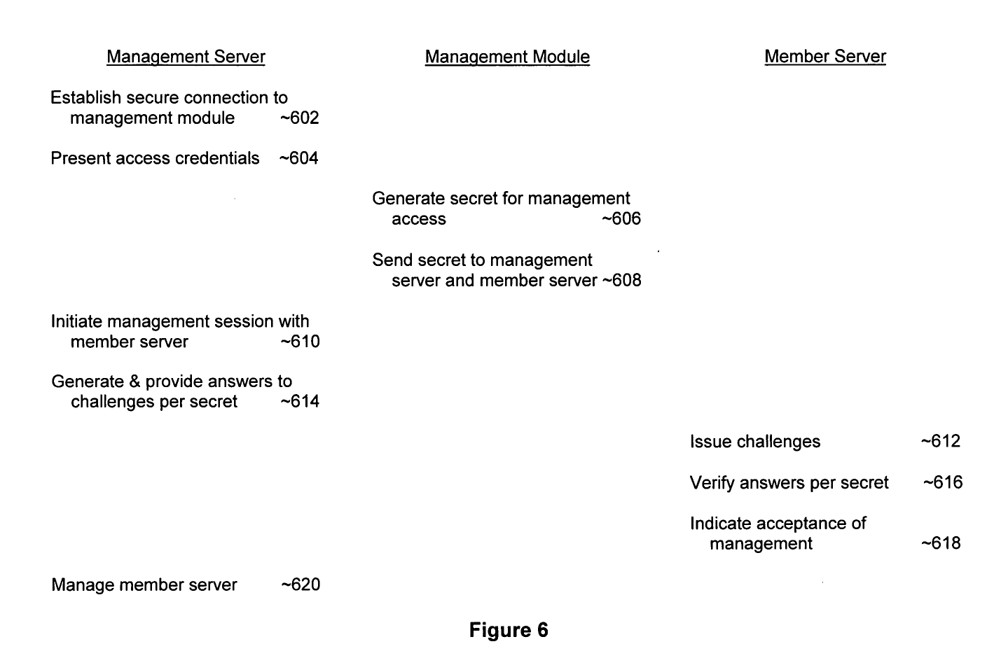

Interfaces 204-208 may be any one of a broad range of these interfaces known in the art or to be designed. CMC 202 may be implemented with a general purpose controller programmed with firmware and/or software implementing the operating logic, reconfigurable integrated circuit (such as, field programmable gate arrays) reconfigured with combinatorial circuits implementing the operating logic, or an application specific integrated circuit (ASIC) having circuitry implementing the operating logic. The operating logic of CMC 202 will be further described below referencing FIG. 5-6.

FIG. 3 illustrates a member server 104 in further detail, in accordance with one embodiment. For the embodiment, member server 104 includes server management controller (SMC) 110. Additionally, member server 104 includes processor 302, memory 304, and bus interface 306 coupled to each other and management controller 110 via bus 308. Each of processor 302, memory 304, bus interface 306 and bus 308 may be any one of a broad range of the corresponding elements known in the art or to be designed.

Similar to CMC 202, SMC 110 may be implemented with a general purpose controller programmed with firmware and/or software implementing its operating logic, reconfigurable integrated circuit (such as, field programmable gate arrays) reconfigured with combinatorial circuits implementing its operating logic, or an application specific integrated circuit (ASIC) having circuitry implement its operating logic. The operating logic of SMC 110 will be further described below referencing FIG. 5-6.

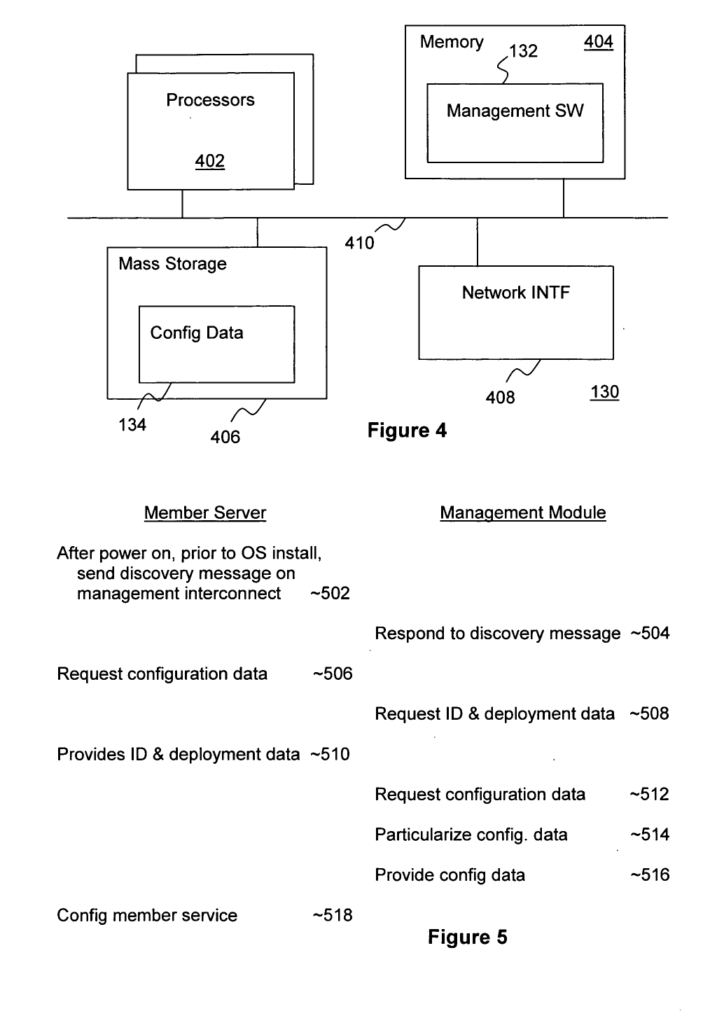

FIG. 4 illustrates management server 130 in further detail, in accordance with one embodiment. As described earlier, management server 130 includes management software (MS) 132 and configuration data 134. Additionally, management server 130 includes processor 402, memory 404 (storing MS 132), mass storage 406 (storing configuration data 134) and network interface 408 coupled to each other via bus 410. Similarly, each of processor 402, memory 404, mass storage 406, network interface 408 and bus 410 may be any one of a broad range of the corresponding elements known in the art or to be designed.

MS 132 may be implemented in any one of a number of programming languages, including but are not limited to the C programming language, C#, Java, Visual Basic, Assembler, and so forth. Its operating logic will also be further described below referencing FIG. 5-6.

Configuration data 134 may be organized and stored in any one of a number of data organization techniques known in the art or to be designed, including but are not limited to flat files, hierarchical or relational databases.

Referring now to FIG. 5, wherein portions of the operating logic of SMC 110, CMC 202, and MS 132, in support of the initial installation of a member server 104 into collection/cluster 102, is shown. For the purpose of the present application, the term “initial installation” includes relocation of a member server 104 within collection/cluster 102, e.g. from one slot of a chassis to another slot.

As illustrated, after power on of a member server 104, prior to the installation of operating system, SMC 110 broadcasts a discovery message onto management interconnect 114 in accordance with a predetermined communication protocol, op 502. The broadcast may e.g. be directed towards a predetermined port of a “listening” device/module. At this time, management controller 110 is unaware of the presence and identity of management module 108. As described earlier, the communication protocol may be any one of a number of known or to be designed open or proprietary protocols.

In response, CMC 202, on receipt of the discovery message, responds to the discovery message, op 504. In various embodiments, CMC 202 responds with the identification data of management module 108.

Next, SMC 110 sends a request for configuration data to management module 108, op 506. SMC 110 may conditionally send the request upon determining that it lacks or not having all necessary configuration data.

For the embodiment, CMC 202 responds with a request for the member server's identification and deployment data, op 508. Identification data may include the member server's model and/or serial number. Deployment data may include the physical location, such as rack number, slot number, bus and/or network addresses.

In response, SMC 110 provides the host member server's identification and deployment data, op 510.

For the embodiment, CMC 202 in turn requests the configuration data from management server 130, op 512. In various embodiments, the configuration data are requested by, and provided to CMC 202, based on the identification data of member server 104. In various embodiments, the request and provision may be made in the form of Hypertext Transmission Protocol (HTTP) request and response, File Transfer Protocol (FTP) request and response, or other protocols with like capabilities.

At 514, CMC 202 particularizes the obtained configuration data, based on the received deployment data. Thereafter, CMC 202 provides the particularized configuration data to SMC 110, op 516.

On receipt, SMC 110 configures member server 102 accordingly, op 518.

Thereafter, operating system may be installed, and computations may be performed on the member server 104. Further, member server 104 may be managed by management server 130, with management module 108 facilitating in ensuring that the management is authorized.

In alternate embodiments, in addition to the identification data, CMC 202 may also provide management server 130 with the deployment data, and management server 130 particularizes the configuration data prior to providing them to CMC 202, that is with management server 130 also assuming the responsibility of particularizing configuration data to a deployment. In other embodiments, the assistance may be partial, that is with management server 130 performing a part of the particularization, and CMC 202 performing the remaining part.

FIG. 6 illustrates portions of the operation flow of MS 132, CMC 202 and SMC 110 for managing member server 104. As illustrated, to manage a member server 104, for the embodiment, MS 132 of a management server 130 first establishes a secure connection to management module 108, op 602. In various embodiments, the secure connection may be a Secure Socket Layer (SSL) connection, a Transport Level Security (TLS) connection or a HTTP Secure (HTTPS) connection.

Upon establishing the secured connection, MS 132 presents CMC 202 with its credentials for accessing a member server 104, op 604.

Assuming management server 130 is authorized to manage the member server 104 and MS 132 presented the proper management access credentials, CMC 202 generates a secret to facilitate the management, op 606. In one embodiment, the secret is a random number that MS 132 and SMC 110 can use in a random number secret based challenge/response authentication.

Thus, on generating the secret, CMC 202 sends the secret to MS 132 (via the established secure connection) and SMC 110 (via management interconnect 114), op 608.

On receipt, MS 132 initiates a management session with the member server 104, op 610.

In response, SMC 110 generates one or more challenges for MS 132, op 612. MS 132 then generates the answers, and responds accordingly, based on the secret, op 614. SMC 110 verifies the correctness of the answers provided, op 616, based on the secret received. Assuming the answers verify correctly, SMC 110 indicates to MS 132 that it is ready to accept management by management server 130, op 618. In various embodiments, the challenges and response may be conducted in accordance with the Challenge Handshake Application Protocol (CHAP).

Thereafter, MS 132 proceeds to manage the member server 104.as desired, op 620.

### Conclusion and Epilogue

Thus, it can be seen from the above descriptions, various novel servers, management modules, and server management methods have been described. While the present invention has been described in terms of the foregoing embodiments, those skilled in the art will recognize that the invention is not limited to the embodiments described. The present invention can be practiced with modification and alteration within the spirit and scope of the appended claims.

Thus, the description is to be regarded as illustrative instead of restrictive on the present invention.

1. In a member server of a community of servers, a method of operation, comprising:
transmitting after power on of the member server, prior to operating system installation on the member server, a discovery message onto a management interconnect of the community;
receiving via the management interconnect, a response from a management module of the community;
transmitting via the management interconnect, a request for configuration data to the management module;
receiving via the management interconnect, configuration data from the management module; and
configuring the member server in accordance with the received configuration data.

2. The method of claim 1, wherein the method further comprises receiving via the management interconnect, a request for identification data of the member server from the management module; and
transmitting via the management interconnect, the requested identification data to the management module.

3. In a management module of a community of servers, a method of operation comprising:
receiving via a management interconnect of the community, a discovery message from a member server;
transmitting via the management interconnect, a response to the discovery message to the member server;
receiving via the management interconnect, a request for configuration data from the member server; and
transmitting via the management interconnect, configuration data to the member server.

4. The method of claim 3, wherein the method further comprises obtaining the configuration data from a remote management server via a network connection connecting the management module to the remote management server.

5. The method of claim 3, wherein the method further comprises
transmitting via the management interconnect, a request for identification and deployment data of the member server to the member server;
receiving via the management interconnect, the requested identification and deployment data of the member server from the member server; and
generating the configuration data based at least in part on the received identification and deployment data of the member server.

6. The method of claim 5, wherein said generating comprises obtaining non-deployment specific configuration data based at least in part on the received identification data, and particularizing the non-deployment specific configuration data based at least in part on the received deployment data.

7. A server, suitable for use as a member server of a community of servers, comprising:
an interconnect interface to couple the server to a management interconnect of the community;
a server management controller coupled to the interconnect interface to transmit after power on, prior to operating system installation, a discovery message onto the management interconnect through the interconnect interface;
receive from the management interconnect, through the interconnect interface, a response from a management module of the community;
transmit through the interconnect interface and the management interconnect, a request for configuration data to the management module;
receive through the management interconnect and the interconnect interface, configuration data from the management module; and
configure the server in accordance with the received configuration data.

8. The server of claim 7, wherein the server management controller is further designed to
receive through management interconnect and the interconnect interface, a request for identification data of the server from the management module; and
transmit through the interconnect interface and the management interconnect, the requested identification data to the management module.

9. A community management module for a community of member servers, comprising:
a first interconnect interface to couple the management module to a management interconnect of the community; and
a community management controller coupled to the first interconnect interface to
receive through the management interconnect and the first interconnect interface, a discovery message from a member server of a community of servers;
transmit through the first interconnect interface and the management interconnect, a response to the discovery message to the member server;
receive through the management interconnect and the first interconnect interface, a request for configuration data from the member server; and
transmit through the first interconnect interface and the management interconnect, configuration data to the member server.

10. The community management module of claim 9, wherein the community management module further comprises a second interconnect interface, and the community management controller is further coupled to the second interconnect interface and equipped to obtain the configuration data from a remote management server through the second interface.

11. The community management module of claim 9, wherein the community management controller is further equipped to
transmit through the interconnect interface and the management interconnect, a request for identification and deployment data of the member server to the member server;
receive through the management interconnect and the interconnect interface, the requested identification and deployment data of the member server from the member server; and
generate the configuration data based at least in part on the received identification and deployment data.

12. The community management module of claim 11, wherein the community management module further comprises a second interconnect interface, and the community management controller is further coupled to the second interconnect interface and equipped to
obtain non-deployment specific configuration data based at least in part on the received identification data, and
particularize the non-deployment specific configuration data based at least in part on the received deployment data.

13. A system comprising:
a management module;
a management interconnect coupled to the management module; and
a first server coupled to the management interconnect, equipped to transmit after power on of the first server, prior to operating system installation on the server, a discovery message onto the management interconnect;
receive via the management interconnect, a response from the management module;
transmit via the management interconnect, a request for configuration data to the management module;
receive via the management interconnect, configuration data from the management module; and
configure the first server in accordance with the received configuration data.

14. The system of claim 13, wherein the first server is further designed to
receive via the management interconnect, a request for identification data of the first server; and
transmit via the management interconnect, the requested identification data to the management module.

15. The system of claim 13, wherein the system further comprises a second server similarly equipped with the enumerated capabilities of the first server, and coupled to the management interconnect.

16. The system of claim 15, wherein the system further comprises a chassis, and the management module, the management interconnect, and the first and second servers are disposed within the chassis.

17. In a management server, a method of operation, comprising:
establishing a secure link to a management module of a community of servers;
transmitting via the secure link the management server's credential for accessing a member server of the community of servers; and
receiving from the management module through the secure link, a secret for use to access the member server.

18. The method of claim 17, further comprising
initiating a management session with the member server;
receiving one or more challenges from the member server;
answering the challenges employing the secret; and
managing the member server.

19. In a community management module of a community of servers, a method of operation, comprising:
receiving from a remote management server over a secure link, a request to access a member server of the community of servers;
authenticating the remote management server;
generating a secret; and
transmitting the secret via the secure link to the management server, and via a management interconnect of the community, to the member server.

20. The method of claim 19, wherein said generating a secret comprises generating a random number.

21. In a member server of a community of servers, a method of operation, comprising:
receiving a secret from a management module of the community via a management interconnect of the community;
receiving initiation of management session from a management server;
issuing challenges to the management server;
receiving responses to the challenges from the management server; and
validating the responses employing the secret.

22. The method of claim 21, wherein the method further comprises accepting management by the management server.

23. A management server comprising:
a networking interface;
memory having stored therein instructions designed to establish a secure link to a management module of a community of servers,
transmit via the secure link the management server's credential for accessing a member server of the community of servers, and
receive from the management module through the secured link, a secret for use to access the member server; and
at least one processor coupled to the memory to execute the instructions.

24. The management server of claim 23, wherein the instructions are further designed to initiate a management session with the member server;
receive one or more challenges from the member server;
answer the challenges employing the secret; and
manage the member server.

25. A management module, comprising:
a first and a second interface; and
a controller coupled to the interface to receive from a remote management server over a secured link through the first interface, a request to access a member server of the community of servers;
authenticate the remote management server; generate a secret; and
transmit the secret via the secure link to the management server, and via a management interconnect through the second interface, to the member server.

26. The management module of claim 25, wherein the controller is further equipped to generate the secret by generating a random number.

27. A member server of a community of servers, comprising:
first and second interfaces;
a server management controller coupled to the first and second interfaces equipped to
receive a secret from a management module of the community of servers through the first interface;
receiving initiation of management session from a management server through the second interface;
issuing challenges to the management server through the second interface;
receiving responses to the challenges from the management server through the second interface; and
validating the responses employing the secret.

28. The member server of claim 27, wherein the server management controller is further equipped to accept management commands for managing the member server from the management server.

29. A system comprising:
a management interconnect;
a member server coupled to the management interconnect; and
a management module coupled to the management interconnect, and equipped to cooperate with a management server in the establishment of a secure link, to receive the management server's credentials for accessing the member server, to generate a secret, and to provide the secret to the management server and the member server.

30. The system of claim 29, wherein
the system further comprises a management server equipped to establish a secure link with the management module, present its credentials for accessing the member server, and receive a secret to facilitate accessing the member server.
